(19) United States
(12) Patent Application Publication
(10) Pub. No.: US 2026/0287633 A1
(43) Pub. Date: Sep. 24, 2026

(54) FAULT LOCATION METHOD AND DEVICE FOR DISTRIBUTION NETWORK, EQUIPMENT, STORAGE MEDIUM, AND PROGRAM PRODUCT

(71) Applicant: STATE GRID NANJING POWER SUPPLY COMPANY, Nanjing City (CN)

(72) Inventors: Lei WEI, Nanjing City (CN); Hong ZHU, Nanjing City (CN); Hong Hua XU, Nanjing City (CN); Xiao Feng WANG, Nanjing City (CN); Lan LAN, Nanjing City (CN); Zhan LU, Nanjing City (CN); Ke Feng ZHOU, Nanjing City (CN); Ye JI, Nanjing City (CN); Zi Jian HU, Nanjing City (CN); Yu Peng SUN, Nanjing City (CN); Yu Jie SHEN, Nanjing City (CN)

(73) Assignee: STATE GRID NANJING POWER SUPPLY COMPANY, Nanjing City (CN)

(21) Appl. No.: 19/365,702

(22) Filed: Oct. 22, 2025

(30) Foreign Application Priority Data
Mar. 19, 2025 (CN) 202510326739.X

(51) Int. Cl. G01R 31/08; H02J 13/00

(52) U.S. Cl. CPC G01R 31/088; H02J 13/12

(57) ABSTRACT

A fault location method and device for a distribution network, equipment, a storage medium, and a program product. Method includes: acquiring node at least one network node' state data in a power network and constructing a power network state incidence matrix based on each network node's state data; and determining a power grid characteristic constraint of the power network state incidence matrix and determining a fault section corresponding to the power network state incidence matrix according to power grid characteristic constraint and a preset fault location model. The fault section located by analyzing the power network state incidence matrix. Through a precise boundary, the preset fault location model can accurately identify a fault characteristic, such that the fault location precision is improved. The power network state incidence matrix and power grid characteristic constraint can be adjusted based on a dynamic change of a topological structure of a power network.

### TECHNICAL FIELD

The present disclosure relates to the technical field of fault location of power systems, and in particular to, a fault location method and device for a distribution network, equipment, a storage medium, and a program product.

### BACKGROUND

In the daily operation of a power network, fault location is the cornerstone for ensuring the safe and stable operation of the power grid. A distribution network serves as a key component of the power network. The topological structure of the network is usually in a state of dynamic change. In addition to the diversity of load types, fault location in the power grid becomes a relatively complex and difficult problem. Conventional fault location methods mainly rely on fixed network models and parameters, which hardly capture the dynamic characteristics of the distribution network precisely, such that the fault location precision is affected. In addition, with the continuous complexity of the power grid structure and continuous expansion of the scale, the calculation efficiency of the conventional fault location methods cannot meet the actual requirements. Therefore, how to provide a fault location method capable of being adapted to the dynamic change of the power grid topology and ensuring efficient and precise fault location becomes a problem to be urgently solved in the technical field of fault location of power systems.

### SUMMARY

Embodiments of the present disclosure provide a fault location method and device for a distribution network, equipment, a storage medium, and a program product. In the embodiments of the present disclosure, the fault location time of the distribution network is shortened, the fault location precision of the distribution network is improved, and the adaptability of the fault location method for the distribution network to the topological change of the network is enhanced.

In one aspect of the embodiments of the present disclosure, a fault location method for a distribution network is provided, including:
acquiring node state data of at least one network node in a power network and constructing a power network state incidence matrix based on the node state data of each network node; and
determining a power network characteristic constraint of the power network state incidence matrix, and determining a fault section corresponding to the power network state incidence matrix according to the power network characteristic constraint and a preset fault location model.

In another aspect of the embodiments of the present disclosure, a fault location device for a distribution network is provided, including:
an incidence matrix construction module, configured to acquire node state data of at least one network node in a power network and construct a power network state incidence matrix based on the node state data of each network node; and
a fault section determination module, configured to determine a power network characteristic constraint of the power network state incidence matrix and determine a fault section corresponding to the power network state incidence matrix according to the power network characteristic constraint and a preset fault location model.

In another aspect of the embodiments of the present disclosure, equipment is provided, including:
at least one processor; and
a memory in communication connection to the at least one processor, where
the memory stores a computer program capable of being executed by the at least one processor, the computer program being executed by the at least one processor to cause the at least one processor to perform the fault location method for a distribution network according to any one of the embodiments of the present disclosure.

In another aspect of the embodiments of the present disclosure, a computer-readable storage medium is provided, including:
a computer instruction, configured to cause a processor to execute the computer instruction, so as to implement the fault location method for a distribution network according to any one of the embodiments of the present disclosure.

In another aspect of the embodiments of the present disclosure, a computer program product is provided, including:
the memory stores a computer program capable of being executed by the at least one processor, the computer program being executed by the at least one processor to cause the at least one processor to perform the fault location method for a distribution network according to any one of the embodiments of the present disclosure.

In the embodiments of the present disclosure, in the power network, in the step of acquiring the node state data which may characterize an operation condition of the network node of at least one network node, by using the node state data of each network node as matrix elements, the power network state incidence matrix capable of describing the incidence relationship among the nodes can be constructed to acquire the preset power grid characteristic constraint, configured to identify the preset fault location model of a fault in the power network and provide a boundary and limitation to fault location, where the power grid characteristic constraint can be determined according to a physical law and/actual requirement of operation of the power system, the power network state incidence matrix and the power grid characteristic constraint can be inputted into the preset fault location model, and the preset fault location model can output the fault section where a fault occurs in the power network by using the power network state incidence matrix and the power grid characteristic constraint. In the embodiments of the present disclosure, the power network structure is simplified by constructing the power network state incidence matrix. The fault section can be located by analyzing the power network state incidence matrix, such that the fault location time is shortened. Through a precise boundary provided by the power grid characteristic constraint, the preset fault location model can accurately identify a fault characteristic, such that the fault location precision of the distribution network is improved. The power network state incidence matrix and the power grid characteristic constraint can be flexibly adjusted based on the dynamic change of the topological structure of a power network, such that the adaptability of the method to the dynamic change of the topological structure of the network is enhanced, and the robustness of the fault location method for a distribution network is improved.

It should be understood that the content described in this section is not intended to identify key or important features of the embodiments of the present disclosure, nor is it used to limit the scope of the present disclosure. Other features of the present disclosure will become readily understandable through the following specification.

### BRIEF DESCRIPTION OF DRAWINGS

In order to describe the technical solutions in the embodiments of the present disclosure more clearly, the drawings needed to be used in the description of the embodiments will be briefly introduced. Apparently, the drawings described below are merely some embodiments of the present disclosure. Those of ordinary skill in the art can still obtain other drawings according to these drawings without making creative labor.

FIG. 1 is a flowchart of a fault location method for a distribution network provided in Embodiment I of the present disclosure.

FIG. 2 is a flowchart of another fault location method for a distribution network provided in Embodiment II of the present disclosure.

FIG. 3 is a flowchart of another fault location method for a distribution network provided in Embodiment III of the present disclosure.

FIG. 4 is a schematic diagram of a structural equation provided in Embodiment III.

FIG. 5 is a flowchart of an artificial hummingbird algorithm provided in Embodiment III of the present disclosure.

FIG. 6 is a schematic diagram of virtual fault points added in a fault line of a distribution network provided in Embodiment III of the present disclosure.

FIG. 7 is a schematic structural diagram of a device for a fault location method for a distribution network provided in Embodiment I of the present disclosure.

FIG. 8 is a device block diagram of a fault location method for a distribution network provided in Embodiment I of the present disclosure.

### DESCRIPTION OF EMBODIMENTS

In order to make those skilled in the art better understand the solutions of the present disclosure, the technical solutions in the embodiments of the present disclosure will be described clearly and completely below in conjunction with the drawings in the embodiments of the present disclosure. Apparently, the described embodiments are merely a part of the embodiments of the present disclosure, rather than all the embodiments. Based on the embodiments of the present disclosure, all other embodiments obtained by those of ordinary skill without making creative labor shall fall within the protection scope of the present disclosure.

It should be noted that the terms “first”, “second”, and the like in the description and claims of the present disclosure and in the drawings are used to distinguish between different objects, and are not used to describe a specific sequence or a precedence order. It should be understood that data used in this manner may be interchanged where appropriate, so that the embodiments of the present disclosure described herein can be implemented in an order other than those illustrated or described herein. Furthermore, the terms “comprise” and “have” and any variations thereof are intended to cover a non-exclusive inclusion, for example, a process, method, system, product, or apparatus that includes a series of steps or units is not necessarily limited to those steps or units explicitly listed, but may include other steps or units not explicitly listed or inherent to such processes, methods, products, or apparatuses.

### Embodiment I

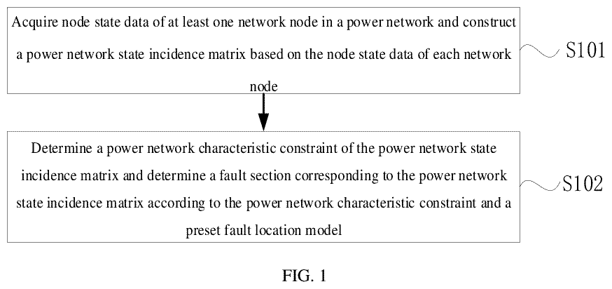

FIG. 1 is a flowchart of a fault location method for a distribution network provided in Embodiment I of the present disclosure. The embodiment of the present disclosure is applicable to fault location of a power network with a dynamic change of a topological structure. The fault location device for a distribution network can be achieved in the form of hardware and/or software. The fault location device for a distribution network can be configured in the equipment. As shown in FIG. 1, the method includes:

S101, node state data of at least one network node in a power network is acquired, and a power network state incidence matrix is constructed based on the node state data of each network node.

The node state data may be understood as a series of information that may characterize the operation condition of the network nodes. Exemplarily, the node state data may include information such as a node voltage value, a node current value, or a node power value.

The power network state incidence matrix may be understood as a mathematical tool that may describe the incidence relationship among the nodes in the power network. It may be understood that the number of row vectors of the power network state incidence matrix is equal to the number of network nodes in the power network, and column vectors of the power network state incidence matrix reflect the impact of other node states on the benchmark node state.

Specifically, in the step of acquiring node state data of at least one network node, which may characterize the operation condition of the network nodes in the power network, the node state data of each network node may be used as a matrix element to construct the power network state incidence matrix, which may describe the incidence relationship among the nodes in the power network. It may be understood that with the operation of the power system and the update of the data, the matrix element in the power network state incidence matrix may be updated continuously.

Exemplarily, the way of acquiring the node state data may include: a sensor may be mounted at each network node, and the node state data collected by the sensor is acquired in a wired or wireless manner, or is measured and acquired by means of manually carried portal equipment.

S102, a power grid characteristic constraint of the power network state incidence matrix is determined, and a fault section corresponding to the power network state incidence matrix is determined according to the power grid characteristic constraint and a preset fault location model.

The power grid characteristic constraint may be understood as a series of information configured to provide boundaries and limitation for fault location, which may be determined according to a physical rule and/or actual requirement of operation of the power system.

The preset fault location model may be understood as a preset mathematical model configured to identify faults in the power network. It may be understood that the preset fault location model may be constructed based on a fault analysis theory of the power system and a large amount of historical data. In the preset fault location model, a change characteristic and rule of the power network state data may be preset to locate the fault section.

The fault section may be understood as a specific line or node range with a fault occurring in the power network, and the power network may be examined and maintained in a targeted manner according to the fault section outputted by means of the preset fault location model, such that the fault processing efficiency of the power network may be improved.

Specifically, in the step of acquiring the preset fault location model configured to identify faults in the power network and the power grid characteristic constraint configured to provide boundary and limitation for fault location, the power grid characteristic constraint may be determined according to a physical law and/actual requirement of operation of the power system, the power network state incidence matrix and the power grid characteristic constraint may be inputted into the preset fault location model, and the preset fault location model may output the fault section where a fault occurs in the power network by using the power network state incidence matrix and the power grid characteristic constraint.

In the embodiments of the present disclosure, in the power network, in the step of acquiring the node state data which may characterize an operation condition of the network node of at least one network node, by using the node state data of each network node as a matrix element, the power network state incidence matrix capable of describing the incidence relationship among the nodes can be constructed to acquire the preset power grid characteristic constraint, configured to identify the preset fault location model of a fault in the power network and provide a boundary and limitation to fault location, where the power grid characteristic constraint can be determined according to a physical law and/actual requirement of operation of the power system, the power network state incidence matrix and the power grid characteristic constraint can be inputted into the preset fault location model, and the preset fault location model can output the fault section where a fault occurs in the power network by using the power network state incidence matrix and the power grid characteristic constraint. In the embodiments of the present disclosure, the power network structure is simplified by constructing the power network state incidence matrix. The fault section can be located by analyzing the power network state incidence matrix, such that the fault location time is shortened. Through a precise boundary provided by the power grid characteristic constraint, the preset fault location model can accurately identify a fault characteristic, such that the fault location precision of the distribution network is improved. The power network state incidence matrix and the power grid characteristic constraint can be flexibly adjusted based on the dynamic change of the topological structure of a power network, such that the adaptability of the method to the dynamic change of the topological structure of the network is enhanced, and the robustness of the fault location method for a distribution network is improved.

### Embodiment II

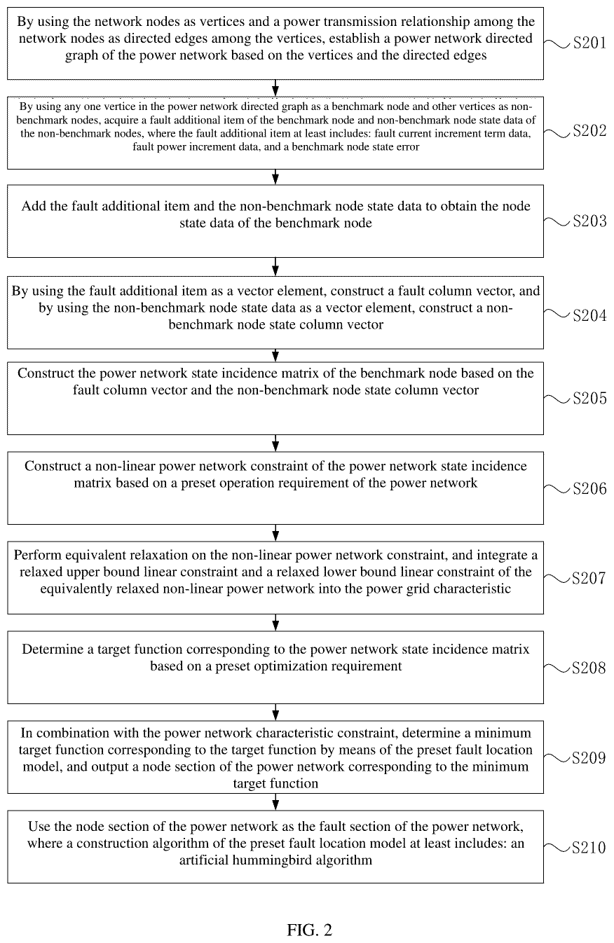

FIG. 2 is a flowchart of another fault location method for a distribution network provided in Embodiment II of the present disclosure. Based on the above embodiment, this embodiment of the present disclosure provides another fault location method for a distribution network. As shown in FIG. 2, the method includes:

S201, by using the network nodes as vertices and a power transmission relationship among the network nodes as directed edges among the vertices, a power network directed graph of the power network is established based on the vertices and the directed edges.

The network nodes refer to various components in the power network. Exemplarily, the network nodes may include components such as a sensor or a power source.

The power transmission relationship may be understood as an interactive relationship among the network nodes. Exemplarily, the power transmission relationship may include: an active power transmission relationship, a reactive power transmission relationship, or the like. Whether the power network is in a normal operating state may be judged by monitoring the power transmission relationship among the network nodes.

The power network directed graph may be understood as a structure formed by vertices and directed edges. In the power network directed graph, the network nodes in the power network may be abstracted as the vertices, and the power transmission relationship among the network nodes may be abstracted as the directed edges.

Specifically, the power transmission relationships among all nodes and each pair of nodes in the power network may be determined, all nodes in the power network may be abstracted as the vertices, the power transmission relationship between each pair of vertices in all the vertices may be abstracted as the directed edge of each pair of vertices, and the power network directed graph may be constructed based on all the abstracted vertices and directed edge between each pair of vertices in all the vertices.

It may be understood that in the power network directed graph, the direction of the power transmission relationship may be used as the direction of the directed edge, and the magnitude of power transmission may be used as a weight of the directed edge.

S202, by using any one vertice in the power network directed graph as a benchmark node and other vertices as non-benchmark nodes, a fault additional item of the benchmark node and non-benchmark node state data of the non-benchmark nodes are acquired, where the fault additional item at least includes: fault current increment term data, fault power increment data, and a benchmark node state error.

The benchmark node may be understood as a reference node, which is a vertice optionally selected from all the vertices in the power network directed graph. It may be understood that in subsequent fault analysis, the node state of the benchmark node may be associated with the node states of other nodes. Exemplarily, the node state of the benchmark node may be represented by the node states of all other nodes.

The non-benchmark node is a network node corresponding to all other vertices except for the benchmark node relative to the benchmark node. It may be understood that in subsequent fault analysis, related data of the non-benchmark node may be processed based on the benchmark node.

The fault additional item may be understood as a series of fault-related extra data items. Exemplarily, the fault additional item at least includes: fault current increment data, fault power increment data, and a benchmark node state error, where the fault current increment data may be understood as a variable quantity of the benchmark node current when the power network has a fault; the fault power increment data may be understood as a variation quantity of the benchmark node power when the power network has a fault; and the benchmark node state error refers to a difference value between actual operating state data of the benchmark node and the calculated state data.

The non-benchmark node state data may be understood as a series of information configured to characterize the operation condition of the non-benchmark node. Exemplarily, the non-benchmark node may include: information such as a node voltage value of the non-benchmark node, a node current value of the non-benchmark node, or a node power value of the non-benchmark node.

Specifically, the power network directed graph, one optionally selected vertice may be used as the benchmark node in the power network directed graph, the rest of all the vertices except for the benchmark node may be used as the non-benchmark node, the series of fault-related fault additional items generated at the benchmark node and the non-benchmark node state data configured to characterize the operation condition of the non-benchmark node and generated at all non-benchmark nodes may be acquired when the power network has a fault, and subsequent operating steps may be performed based on the fault additional item and the non-benchmark node state data.

It may be understood that in the power network directed graph, all the vertices may have the opportunity to be selected as the benchmark node for subsequent operations.

S203, the fault additional item and the non-benchmark node state data are added to obtain the node state data of the benchmark node.

Specifically, in the step of acquiring the fault additional item of the benchmark node and the non-benchmark node state data of the non-benchmark node, the fault additional item and the non-benchmark node state data may be added, and the result data obtained by adding the non-benchmark node state data may be used as the node state data of the benchmark node.

S204, by using the fault additional item as a vector element, a fault column vector is constructed, and by using the non-benchmark node state data as a vector element, a non-benchmark node state column vector is constructed.

The fault column vector is a vector formed by arranging the fault additional items of the benchmark nodes in a column in a certain order, which is configured to form the power network state incidence matrix of the power network.

The non-benchmark node state column vector is a vector formed by arranging the non-benchmark node state data in a column in a certain order, which is also configured to form the power network state incidence matrix of the power network.

Specifically, the acquired fault additional item of the benchmark node may be used as a vector element, and the vector element is arranged in a certain order as a first column vector. The first column vector may be used as the fault column vector. The acquired non-benchmark node state data of the non-benchmark nodes may be used as a vector element, and the vector element is arranged in a certain order as a second column vector. The second column vector may be used as a non-benchmark node state column vector.

Exemplarily, the step of acquiring the fault column vector and the non-benchmark node state column vector may further include: all the vertices in the power network directed graph are used as primary benchmark nodes, the fault additional items of the benchmark nodes and the non-benchmark node state data of all the non-benchmark nodes corresponding to the benchmark nodes may be acquired, the acquired fault additional items of the benchmark nodes may be arranged in a certain order as the fault column vector, and the non-benchmark node state data of the non-benchmark nodes may be arranged in a certain order to form the non-benchmark node state column vector.

S205, the power network state incidence matrix of the benchmark node is constructed based on the fault column vector and the non-benchmark node state column vector.

Specifically, the fault column vector of the benchmark node and the non-benchmark node state column vector of the non-benchmark node are acquired, the acquired fault column vector and non-benchmark node state column vector may be arranged in a row in a certain order to obtain a first row vector, and the first row vector may be used as the power network state incidence matrix.

S206, a non-linear power network constraint of the power network state incidence matrix is constructed based on a preset operation requirement of the power network.

The non-linear power grid constraint may be understood as a series of mathematical relationships, which is configured to limit the relationships between the node state data. Exemplarily, the non-linear power grid constraint may include: upper and lower limit values of a branch current amplitude or a node voltage amplitude.

Specifically, the preset operation requirement of the power network may be acquired, a series of mathematical relationships that limit the relationship between the node state data may be listed based on the incidence between the matrix elements and the preset operation requirement in the power network state incidence matrix, and the series of mathematical relationships may be used as the non-linear power grid constraint.

S207, equivalent relaxation is performed on the non-linear power network constraint, and an upper bound linear constraint and a lower bound linear constraint of the equivalently relaxed non-linear power network are integrated into the power grid characteristic constraint.

Equivalent relaxation may be understood as an approximate processing method, which may be configured to convert the nonlinear constraint into a linear constraint.

The upper bound linear constraint refers to a linear constraint after equivalent relaxation of the nonlinear power grid constraint and defines the upper limit value of a certain variable or some state variables in the power network.

The lower bound linear constraint refers to another linear constraint after equivalent relaxation of the nonlinear power grid constraint and defines the lower limit value of a certain variable or some state variables in the power network.

Specifically, in the step of acquiring the nonlinear power grid constraint, the acquired nonlinear power grid constraint may be subjected to equivalent relaxation by an appropriate processing method. After the equivalent relaxation of the nonlinear power grid constraint, two linear constrains may be acquired, which are respectively the upper bound linear constraint and the lower bound linear constraint, where the upper bound linear constraint defines the upper limit value of a certain variable or some variables in the power network, the lower bound linear constraint defines the lower limit value of a certain variable or some variables in the power network, the upper and lower bound linear constraints may be combined to obtain a combined constraint, and the combined constraint may be used as the power grid characteristic constraint.

S208, a target function corresponding to the power network state incidence matrix is determined based on a preset optimization requirement.

The target function may be understood as a mathematical function, that may measure the difference between the operating state of the power network and an expected target, such that the optimization process has a clear direction and operability.

Specifically, the target function corresponding to the preset optimization requirement and capable of measuring the difference between the operating state of the power network and the expected target may be determined based on the power network state incidence matrix. It may be understood that the target function is obtained by converting the power network state incidence matrix.

S209, in combination with the power network characteristic constraint, a minimum target function corresponding to the target function is determined by means of the preset fault location model, and a node section of the power network corresponding to the minimum target function is outputted, where a construction algorithm of the preset fault location model at least includes: an artificial hummingbird algorithm.

The node section of the power network may be understood as a region including a specific fault location, which defines a specific physical range of the fault in the power network.

Specifically, the target function may be optimally solved by means of the preset fault location model. Under the power grid characteristic constraint, a parameter value that enables the target function to obtain the minimum value may be found by means of the preset fault location model. The preset fault location model may output the specific location range of the fault in the power network according to the parameter value corresponding to the solved maximum target function, and the outputted specific location range may be used as the node section of the power network, where the preset fault location model may be constructed based on the artificial hummingbird algorithm. The artificial hummingbird algorithm is a swarm intelligence optimization algorithm that has a faster convergence speed and a stronger global search capability. The construction of the preset fault location model based on the artificial hummingbird algorithm may improve the fault location accuracy and efficiency.

S210, the node section of the power network is used as the fault section of the power network.

Specifically, in the step of acquiring the node section of the power network in the power network, the node section of the power network may be used as the fault section in the power network, and the power network may be examined and maintained in a targeted manner according to the fault section, such that the fault processing efficiency of the power network is improved.

In the embodiments of the present disclosure, the power transmission relationships among all nodes and each pair of nodes in the power network may be determined, all nodes in the power network may be abstracted as the vertices, the power transmission relationship between each pair of vertices in all the vertices may be abstracted as the directed edge of each pair of vertices, and the power network directed graph may be constructed based on all the abstracted vertices and directed edge between each pair of vertices in all the vertices; the power network directed graph, one optionally selected vertice may be used as the benchmark node in the power network directed graph, the rest of all the vertices except for the benchmark node may be used as the non-benchmark node, the series of fault-related fault additional items generated at the benchmark node and the non-benchmark node state data configured to characterize the operation condition of the non-benchmark node and generated at all non-benchmark nodes may be acquired when the power network has a fault, the fault additional item and the non-benchmark node state data may be added, and result data obtained by adding the non-benchmark node state data may be used as the node state data of the benchmark node; the acquired fault additional item of the benchmark node may be used as a vector element and the vector element is arranged in a certain order as a first column vector, the first column vector may be used as the fault column vector, the acquired non-benchmark node state data of the non-benchmark nodes may be used as a vector element and the vector element is arranged in a certain order as a second column vector, and the second column vector may be used as a non-benchmark node state column vector; the acquired fault column vector and non-benchmark node state column vector may be arranged in a row in a certain order to obtain a first row vector, the first row vector may be used as the power network state incidence matrix, the preset operation requirement of the power network may be acquired, a series of mathematical relationships that limit the relationship between the node state data may be listed based on the incidence between the matrix elements and the preset operation requirement in the power network state incidence matrix, and the series of mathematical relationships may be used as the non-linear power grid constraint; the acquired nonlinear power grid constraint may be subjected to equivalent relaxation by an appropriate processing method, after the equivalent relaxation of the nonlinear power grid constraint, two linear constrains may be acquired, which are respectively the upper bound linear constraint and the lower bound linear constraint, where the upper bound linear constraint defines the upper limit value of a certain variable or some variables in the power network, the lower bound linear constraint defines the lower limit value of a certain variable or some variables in the power network, the upper and lower bound linear constraints may be combined to obtain a combined constraint, and the combined constraint may be used as the power grid characteristic constrain; the target function corresponding to the preset optimization requirement and capable of measuring the difference between the operating state of the power network and the expected target may be determined based on the power network state incidence matrix. It may be understood that the target function is obtained by converting the power network state incidence matrix; the target function may be optimally solved by means of the preset fault location model, under the power grid characteristic constraint, a parameter value which enables the target function obtains the minimum value may be found by means of the preset fault location model, the preset fault location model may output the specific location range of the fault in the power network according to the parameter value corresponding to the solved maximum target function, and the outputted specific location range may be used as the node section of the power network; and the node section of the power network may be used as the fault section in the power network, and the power network may be examined and maintained in a targeted manner according to the fault section, such that the fault processing efficiency of the power network is improved. In this embodiments of the present disclosure, by abstracting the network nodes as the vertices and the power transmission relationships as the directed edges, the directed graph of the power network is established, which simplifies the complex power network structure and enhances the convenience of troubleshooting of the power network; by adding the fault additional items, it may be ensured that the power network state incidence matrix can precisely describe the practical operating state of the benchmark node, thereby enhancing the fault location accuracy of the distribution network; by equivalently relaxing the power grid characteristic constraint as the linear constraint more easily to solve, the process of optimizing the target function by means of the preset fault location model is simplified, the solving speed of the preset fault location model is accelerated, and the fault location efficiency of the distribution network is improved.

Based on the above embodiments, the embodiment of the present disclosure may further include the following steps:
a plurality of virtual fault points are arranged at equal intervals within the fault section, and virtual electric data of each of the virtual fault points is collected by using preset power system simulation software; and virtual electric data is identified by means of the preset fault location model, and a precise fault point of the power network is outputted based on the virtual electric data.

The virtual fault point refers to a fault location point that is not practical in the fault section, which may be configured to acquire a fault location in the power network.

The virtual electric data refers to simulation information obtained when each virtual fault point is subjected to analog simulation by the preset power system simulation software. Exemplarily, the virtual electric data may include simulation information such as a voltage amplitude or a current amplitude.

The precise fault point may be understood as a specific location where a fault occurs in the power network. Based on the precise fault point, the accurate location point where the fault occurs practically in the power network may be accurately obtained.

Specifically, in the step of acquiring the fault section in the power network, a plurality of virtual fault points configured to precisely acquire the fault point in the power network may be disposed along the fault section according to an equally spaced principle in the acquired fault section, analog simulation may be performed on the power network with the virtual fault points by using the preset power system simulation software selected in advance, in the simulation process, the preset power system simulation software may collect the virtual electric data of each virtual fault point and inputs the acquired virtual electric data to the preset fault location model, and the preset fault location model may identify the virtual electric data and output the specific location where the fault occurs in the power network, i.e., the precise fault point where the faults occurs in the power network. The arrangement of the multi-point judgment mechanism for the plurality of virtual faults in each fault section further improves the fault location accuracy and reliability of the distribution network.

### Embodiment III

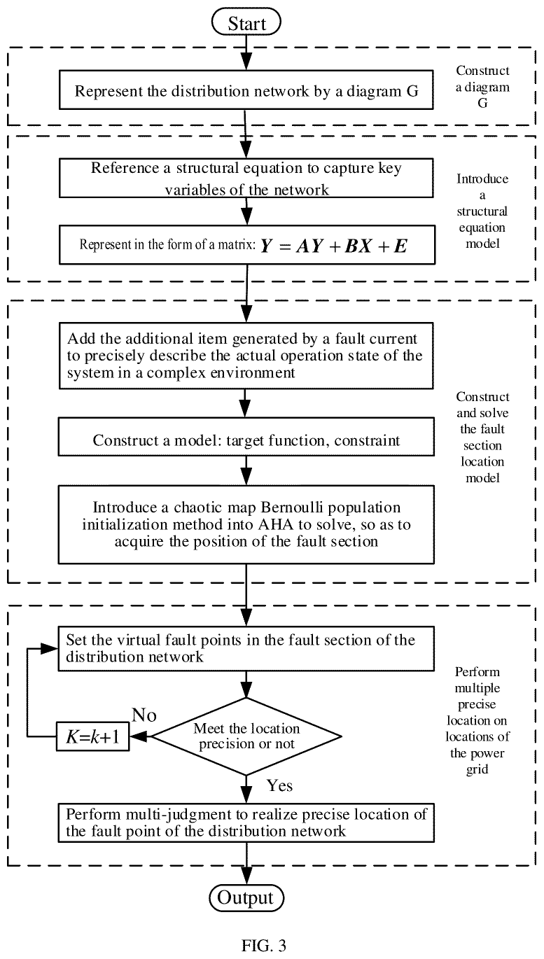

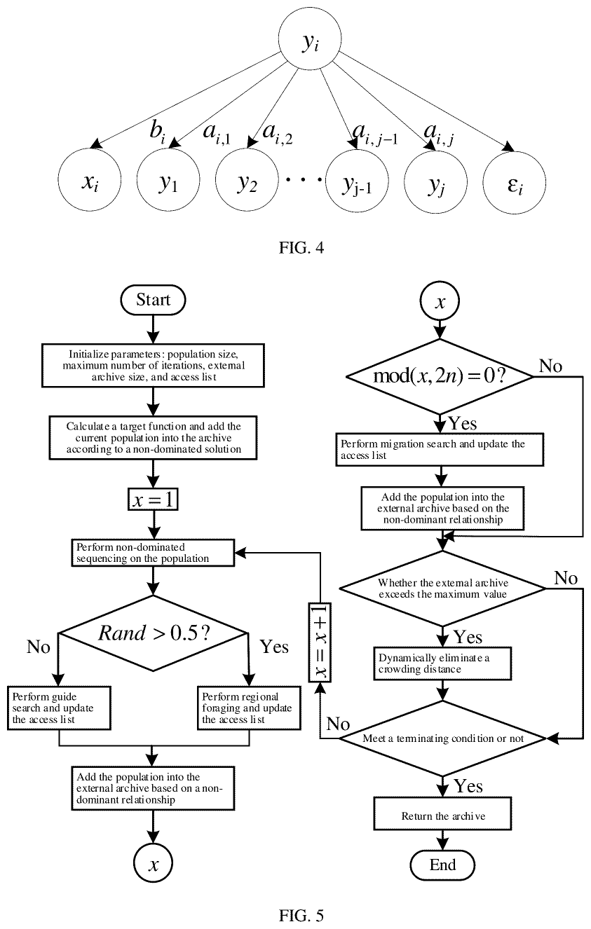

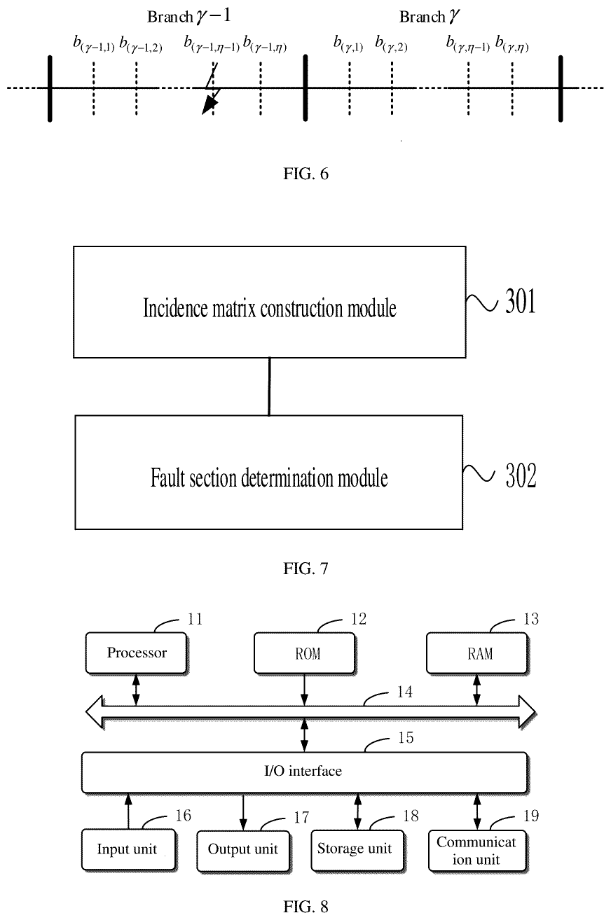

FIG. 3 is a flowchart of another fault location method for a distribution network provided in Embodiment III of the present disclosure. Based on the above embodiment, this embodiment of the present disclosure provides another fault location method for a distribution network. As shown in FIG. 3, the method includes: each element in the power network system is abstracted as a node in the directed graph G, the power transmission relationships among the elements are abstracted as directed edges in the directed graph, and FIG. G is presented by (V,E), where V={V₁, V₂, . . . , Vₖ} represents all the vertices, E={eᵢⱼ} represents all the edges connected to the vertices, and attributes of the nodes and weights of the directed edges may be set according to the practical operation condition and a scheduling target of the power system; by referencing a structural equation model, as shown in FIG. 4, the node state data yᵢ of the power network node i is captured to obtain the incidence of the topological structure of the network, where

$${y}_{i} = {\sum }_{i \neq j} {a}_{i , j} {y}_{j} + {b}_{i} {x}_{i} + {ε}_{i} , \qquad ( 1 )$$

where i, j respectively represent node numbers, i≠j; a_{i,j} and bᵢ are respectively weight coefficients, xᵢ=[x_{U}_{ₓ}, x_{U}_{_{y}}] represents a state variable of the node, where x_{U}_{ₓ} represents a real part of voltage, x_{U}_{_{y}} represents a virtual part of voltage; εᵢ is a state error item of the node i.

The formula (1) may be expressed in the form of a matrix to acquire the node state incidence matrix:

$$Y = AY + BX + E , \qquad ( 2 )$$

where the matrices A, B, and E are respectively matrix expressions corresponding to a_{i,j}, bᵢ, and εᵢ.

A new additional item generated by the fault current is added into node state incidence matrix to precisely describe the actual operation state of the system in a complex environment. It is needed to expand the system state variable to

$${x}_{i}^{′} = [ {x}_{{U}_{x}} , {x}_{{U}_{y}} , {x}_{{I}_{x}} , {x}_{{I}_{y}} ] .$$

Therefore, formula (2) is represented as:

$$Y = AY + {BX}^{′} + E , \qquad ( 3 )$$

when a fault occurs in the network, to precisely describe the actual operation state of the system in a complex environment, an increment Δz corresponding to the fault power is added to a measuring equation:

$$\{ \begin{matrix}Δ {z}_{P , i} = - ( {x}_{{U}_{x} , i} {x}_{{I}_{x} , i} + {x}_{{U}_{y} , i} {x}_{{I}_{y} , i} ) \\ Δ {z}_{Q , i} = - ( {x}_{{U}_{x} , i} {x}_{{I}_{y} , i} - {x}_{{U}_{y} , i} {x}_{{I}_{x} , i} ) \\ Δ {z}_{P , j} = - ( {x}_{{U}_{x} , j} {x}_{{I}_{x} , j} + {x}_{{U}_{y} , j} {x}_{{I}_{y} , j} ) \\ Δ {z}_{Q , j} = - ( {x}_{{U}_{x} , j} {x}_{{I}_{y} , j} - {x}_{{U}_{y} , j} {x}_{{I}_{x} , j} )\end{matrix} , \qquad ( 4 )$$

where Δz_{P} represents an active power component of the increment, Δz_{Q} represents a reactive power component; and X_{I}_{ₓ} represents a real part of the component of the fault current increment, and X_{I}_{_{y}} represents a virtual part.

Therefore, formula (3) may be further represented as formula (5) to acquire the power network state incidence matrix:

$$Y = AY + {BX}^{′} + E + Δ z , \qquad ( 5 )$$

the target function may be determined with the minimum node state error item based on the preset operation requirement of the power network:

$$min ‖ E ‖ = min ‖ Y - AY - {BX}^{′} - Δ z ‖ , \qquad ( 6 )$$

the nonlinear power grid constraint is as follows:

$$\{ \begin{matrix}{I}_{ij} \leq {I}_{ij , max} \\ {U}_{i , min} \leq {U}_{i} \leq {U}_{i , max} \\ {P}_{ij , min} \leq {P}_{ij} \leq {P}_{ij , max} \\ {P}_{ij}^{2} + {Q}_{ij}^{2} , , {S}_{ij , max}^{2} \\ {P}_{g , i} - {P}_{L , i} = {U}_{i} {\sum }_{j = 1}^{n} {U}_{j} ( {G}_{ij} cos {θ}_{ij} + {B}_{ij} sin {θ}_{ij} ) \\ {Q}_{g , i} - {Q}_{L , i} = {U}_{i} {\sum }_{j = 1}^{n} {U}_{j} ( {G}_{ij} sin {θ}_{ij} - {B}_{ij} cos {θ}_{ij} )\end{matrix} , \qquad ( 7 )$$

where I_{ij,max} is an upper limit value of a branch current amplitude; U_{i,max} and I_{i,min} are upper and lower limits of a node voltage amplitude; Pᵢⱼ and Qᵢⱼ are active power and reactive power of a branch i, j; P_{ij,min} and P_{ij,min} are upper and lower bounds of the active power of the branch i, j. S_{ij,max} is the maximum value of apparent power; P_{L,i} is reactive power consumed by a load of the node i. Q_{g,i} is reactive power injected by a power source at the node i; and Q_{L,i} is reactive power consumed by the load at the node i.

The nonlinear power grid constraint may be rewritten by means of formula (8) involved in the equivalent relaxation method to obtain a power grid characteristic constraint formula (9):

$$\{ \begin{matrix}P = p + AP - ARl \\ Q = q + AQ - AXl\end{matrix} , \qquad ( 8 )$$

where P=[Pᵢⱼ] is a matrix representation of the active power of the branch ij, Q=[Qᵢⱼ] is a matrix representation of the reactive power of the branch ij, =[Pᵢⱼ], Q=[Qᵢⱼ], R=diag[Rᵢⱼ]_{n×n}, and X=diag[Xᵢⱼ]_{n×n} present a reactance matrix set,

$$l = {[ {I}_{ij}^{2} ]}_{n} ;$$

the first row of the matrix A0 is a transformer node needed to be removed, letting [0ₙ,I]A₀−I=A, where I is a n-dimensional unit matrix, and 0n is a 0 vector in the row n.

$$\{ \begin{matrix}{I}_{ij} \leq {I}_{ij , max} \\ {U}_{i , min} \leq {U}_{i} \leq {U}_{i , max} \\ {P}_{ij , min} \leq {P}_{ij} \leq {P}_{ij , max} \\ {P}_{ij}^{2} + {Q}_{ij}^{2} , , {S}_{ij , max}^{2} \\ {P}^{+} = Cp - {D}_{R} {l}_{min} \\ {P}^{-} = Cp - {D}_{R} {l}_{max} \\ {Q}^{+} = Cq - {D}_{X +} {l}_{min} - {D}_{X -} {l}_{max} \\ {Q}^{-} = Cq - {D}_{X +} {l}_{max} - {D}_{X -} {l}_{min}\end{matrix} \qquad ( 9 )$$

where D_{X+} and H₊ represent elements of matrices D_{X} and H, which are not less than zero; D_{X-} and H₋ represent elements less than zero;

$${p}^{+} = {P}_{g}^{+} - {P}_{L} and {p}^{-} = {P}_{g}^{-} - {P}_{L} ,$$

where Pg presents a power source matrix of the distribution network;

$${P}_{g}^{+} and {P}_{g}^{-}$$

represent maximum and minimum values of power outputted by a power source; and P_{L} represents a load matrix of each node of the power grid.

In the embodiment of the present disclosure, I may be expressed as:

$${l}_{ij} \approx {l}_{ij}^{0} + {J}_{ij}^{T} {δ}_{ij}^{T} + \frac{1}{2} {δ}_{ij}^{T} {H}_{ij} {δ}_{ij}^{T} , \qquad ( 10 )$$

$$where {δ}_{ij} = [ \begin{matrix}{P}_{ij} - {P}_{ij}^{0} \\ {Q}_{ij} - {Q}_{ij}^{0} \\ {v}_{j} - {v}_{j}^{0}\end{matrix} ] , {J}_{ij} = [ \begin{matrix}\frac{\partial {l}_{ij}}{\partial {P}_{ij}} \\ \frac{\partial {l}_{ij}}{\partial {Q}_{ij}} \\ \frac{\partial {l}_{ij}}{\partial {v}_{j}}\end{matrix} ] , and$$

$${H}_{ij} = [ \begin{matrix}\frac{{\partial }^{2} {l}_{ij}}{\partial {P}_{ij}^{2}} & \frac{{\partial }^{2} {l}_{ij}}{\partial {P}_{ij} \partial {Q}_{ij}} & \frac{{\partial }^{2} {l}_{ij}}{\partial {P}_{ij} \partial {v}_{j}} \\ \frac{{\partial }^{2} {l}_{ij}}{\partial {Q}_{ij} \partial {P}_{ij}} & \frac{{\partial }^{2} {l}_{ij}}{\partial {Q}_{ij}^{2}} & \frac{{\partial }^{2} {l}_{ij}}{\partial {Q}_{ij} \partial {v}_{j}} \\ \frac{{\partial }^{2} {l}_{ij}}{\partial {v}_{j} \partial {P}_{ij}} & \frac{{\partial }^{2} {l}_{ij}}{\partial {v}_{j} \partial {Q}_{ij}} & \frac{{\partial }^{2} {l}_{ij}}{\partial {v}_{j}^{2}}\end{matrix} ]$$

are Hessian matrices.

Deviation of a boundary value 1 may be expressed as:

$${l}_{ij} = \vert {l}_{ij} \vert \approx \vert {l}_{ij}^{0} + {J}_{ij}^{T} {δ}_{ij} + \frac{1}{2} {δ}_{ij}^{T} {H}_{ij} {δ}_{ij} \vert \leq \vert {l}_{ij}^{0} \vert + \vert {J}_{ij}^{T} {δ}_{ij} \vert + \frac{1}{2} \vert {δ}_{ij}^{T} {H}_{ij} {δ}_{ij} \vert \leq {l}_{ij}^{0} + max \{ 2 \vert {J}_{ij}^{T} {δ}_{ij} \vert , \vert {δ}_{ij}^{T} {H}_{ij} {δ}_{ij} \vert \} , \qquad ( 11 )$$

$${l}_{ij} \leq {l}_{ij}^{0} + max \{ 2 \vert {J}_{ij +}^{T} {δ}_{ij +} , {J}_{ij -}^{T} {δ}_{ij -} \vert , \vert {δ}_{ij}^{T} {H}_{ij} {δ}_{ij} \vert \} = {l}_{ij , max} , \qquad ( 12 )$$

$${l}_{ij} \geq {l}_{ij}^{0} + {J}_{ij +}^{T} {δ}_{ij -} + {J}_{ij -}^{T} {δ}_{ij +} = {l}_{ij , min} , \qquad ( 13 )$$

where Jᵢⱼ₊ and Jᵢⱼ₋ are a matrix formed by non-negative elements and a matrix formed by negative elements; and dᵢⱼ₊ and dᵢⱼ₋ are matrices formed by non-negative and negative elements in δᵢⱼ. I_{ij,min} may be a negative value, but

$${l}_{ij} = {I}_{ij}^{2} \geq 0.$$

Therefore, during practical simulation operation, the lower bound value of Iᵢⱼ shall be max{0, I_{ij,min}}; in addition, since two feature values of the Hessian matrices are strictly positive, with one being zero, they are positive semidefinite. Therefore, the boundary of/is convex.

The artificial hummingbird algorithm (AHA) is referenced. Solving is performed based on the power network state incidence matrix and the power grid characteristic constraint by means of the preset fault location model. The model input is the state data of each node. By comparing the node state errors of the nodes, the fault location of the distribution network is determined, and the specific fault location of the line is outputted. The flow of the AHA algorithm is shown in FIG. 3, which mainly includes the following steps: a hummingbird position is initialized, the adaptability is calculated, the position is updated according to individual and neighbor experience, the adaptability is calculated again, the optimal solution is selected, a terminating condition is judged, and if not reached, iteration is performed continuously, and finally, a result is outputted.

A chaos mapping Bernoulli initialization population method may be further added to the artificial hummingbird algorithm to solve the fault location model of the distribution network. The Bernoulli's equation is as follows:

$$x ( t + 1 ) = \{ \begin{matrix}\frac{x ( t )}{1 - λ} , & 0 < x ( t ) \leq 1 - λ \\ \frac{x ( t ) - 1 + λ}{λ} , & 1 - λ < x ( t ) < 1\end{matrix} , \qquad ( 14 )$$

where x(t) is a state variable at time t, x(t+1) is a state variable at time t+1, λ is a constant parameter, where 0≤λ≤1 used for a threshold and a scale factor of a piecewise function.

Chaotic sequences generated by chaotic mapping can produce more diverse and uniform populations, and can improve the solving ability of complex optimization models.

In the embodiments of the present disclosure, the virtual fault points may further be arranged in each section and multiple judgment is performed to achieve precise location of the fault points of the distribution network; upon successfully locating the node closest to where the fault occurs, in order to more precisely identify the exact location of the fault, the present disclosure divides and processes the branch directly connected to the nod more meticulously. This step aims to reduce the fault search range through refined analysis. Specifically, the concept of the virtual fault points is introduced to the fault line of the distribution network in the present disclosure. These virtual points are strategically arranged at key locations and divided at equal intervals according to the line. The faults of the lines among the virtual points are then located, such that multiple state estimation is achieved. The state estimation method each time is the same as the above method. Therefore, the precise location where the fault occurs can be more systematically troubleshot and determined step by step. This way not only improves the precision of fault location of the distribution network, but also enhances the troubleshooting efficiency and effectiveness. The number of the virtual fault point is set as b(γ,η), representing the ηₜₕ virtual fault point in the fault line γ. FIG. 4 shows a schematic diagram of the virtual point added to the fault line of the distribution network.

### Embodiment IV

FIG. 7 shows a device capable of performing a fault location method for a distribution network provided in Embodiment IV of the present disclosure. As shown in FIG. 7, the device includes:
an incidence matrix construction module 301, configured to acquire node state data of at least one network node in a power network and construct a power network state incidence matrix based on the node state data of each network node; and
a fault section determination module 302, configured to determine a power network characteristic constraint of the power network state incidence matrix and determine a fault section corresponding to the power network state incidence matrix according to the power network characteristic constraint and a preset fault location model.

In the embodiments of the present disclosure, in the power network, in the step of acquiring the node state data which may characterize an operation condition of the network node of at least one network node, by using the node state data of each network node as a matrix element, the power network state incidence matrix capable of describing the incidence relationship among the nodes can be constructed to acquire the preset power grid characteristic constraint, configured to identify the preset fault location model of a fault in the power network and provide a boundary and limitation to fault location, where the power grid characteristic constraint can be determined according to a physical law and/actual requirement of operation of the power system, the power network state incidence matrix and the power grid characteristic constraint can be inputted into the preset fault location model, and the preset fault location model can output the fault section where a fault occurs in the power network by using the power network state incidence matrix and the power grid characteristic constraint. In the embodiments of the present disclosure, the power network structure is simplified by constructing the power network state incidence matrix. The fault section can be located by analyzing the power network state incidence matrix, such that the fault location time is shortened. Through a precise boundary provided by the power grid characteristic constraint, the preset fault location model can accurately identify a fault characteristic, such that the fault location precision of the distribution network is improved. The power network state incidence matrix and the power grid characteristic constraint can be flexibly adjusted based on the dynamic change of the topological structure of a power network, such that the adaptability of the method to the dynamic change of the topological structure of the network is enhanced, and the robustness of the fault location method for a distribution network is improved.

Based on the above embodiments, the incidence matrix construction module 301 provided by the embodiment of the present disclosure is specifically configured to:
by using the network nodes as vertices and a power transmission relationship among the network nodes as directed edges among the vertices, establish a power network directed graph of the power network based on the vertices and the directed edges;
by using any one vertice in the power network directed graph as a benchmark node and other vertices as non-benchmark nodes, acquire a fault additional item of the benchmark node and non-benchmark node state data of the non-benchmark nodes; and
add the fault additional item and the state data of the non-benchmark node to obtain the node state data of the benchmark node, where the fault additional item at least includes: fault current increment term data, fault power increment data, and a benchmark node state error.

Based on the above embodiments, the incidence matrix construction module 301 provided by the embodiment of the present disclosure is further specifically configured to:
by using the fault additional item as a vector element, construct a fault column vector, and by using the non-benchmark node state data as a vector element, construct a non-benchmark node state column vector; and
construct the power network state incidence matrix of the benchmark node based on the fault column vector and the non-benchmark node state column vector.

Based on the above embodiments, the fault section determination module 302 provided by the embodiment of the present disclosure is specifically configured to:
construct a non-linear power network constraint of the power network state incidence matrix based on a preset operation requirement of the power network; and
perform equivalent relaxation on the non-linear power network constraint, and integrate a relaxed upper bound linear constraint and a relaxed lower bound linear constraint of the equivalently relaxed non-linear power network into the power grid characteristic.

Based on the above embodiments, the fault section determination module 302 provided by the embodiment of the present disclosure is further specifically configured to:
determine a target function corresponding to the power network state incidence matrix based on a preset optimization requirement;
in combination with the power network characteristic constraint, determine a minimum target function corresponding to the target function by means of the preset fault location model, and output a node section of the power network corresponding to the minimum target function; and
use the node section of the power network as the fault section of the power network, where a construction algorithm of the preset fault location model at least includes: an artificial hummingbird algorithm.

Based on the above embodiments, the fault section determination module 302 provided by the embodiment of the present disclosure is further specifically configured to:
arrange a plurality of virtual fault points at equal intervals within the fault section, and collect virtual electric data of each of the virtual fault points by using preset power system simulation software; and
identify the virtual electric data by means of the preset fault location model, and output a precise fault point of the power network based on the virtual electric data.

### Embodiment V

This embodiment of the present disclosure provides equipment that performs the fault location method for a distribution network, a computer-readable storage medium, and a computer program product.

FIG. 8 shows a schematic structural diagram of the equipment capable of implementing this embodiment of the present disclosure. The equipment aims to represent various forms of digital computers, such as laptop computers, desktop computers, workstations, personal digital assistants (PDA), servers, blade servers, mainframe computers, and other suitable computers. The equipment may also represent various forms of mobile devices, such as personal digital processors, cellular phones, smartphones, wearable devices (e.g., helmets, glasses, watches, etc.), and other similar computing devices. The components shown in the embodiments of the present disclosure, their connections and relationships, and their functions are merely examples, and are not intended to limit the implementation of the embodiments of the present disclosure described and/or claimed herein.

As shown in FIG. 8, the equipment includes at least one processor 11 and a memory in communication connection to the at least one processor 11, such as a read-only memory (ROM) 12 and a random access memory (RAM) 13, where the memory stores a computer program capable of being performed by the at least one processor. The processor 11 may perform various appropriate actions and processing according to the computer program stored in the ROM 12 or the computer program loaded from the memory unit 18 to the RAM 13. In the RAM 13, various programs and data needed by operations of the equipment may also be stored. The processor 11, the ROM 12, and the RAM 13 are connected to each other through a bus 14. An input/output (I/O) interface 15 is also connected to the bus 14.

A plurality of components in the equipment are connected to the I/O interface 1 5, including an input unit 16, such as a keyboard and a mouse; an output unit 17, such as various types of displays, loudspeakers; a storage unit 18, such as a magnetic disk and an optical disc; and a communication unit 19, such as a network card, a modem, and a wireless communication transceiver. The communication unit 19 allows the equipment to exchange information/data with other equipment via computer networks such as the Internet and/or various telecommunications networks.

The processor 11 may be various universal and/or dedicated processing assemblies having processing and computing power. Some examples of the processor 11 include, but are not limited to, a central processing unit, a graphics processing unit, various dedicated artificial intelligence computing chips, various processors that run machine learning model algorithms, a digital signal processor, and any appropriate processor, controller, microcontroller, and the like. The processor 11 performs various methods and processing described above, such as the fault location method for a distribution network.

In some embodiments, the fault location method for a distribution network may be implemented as a computer program, which is tangibly included in a computer readable storage medium, such as a storage unit 18. In some embodiments, part of or all the computer program may be loaded and/or mounted to the equipment via the ROM 12 and/or the communication unit 19. When loaded to the RAM 13 and executed by the processor 11, the computer program may perform one or more steps based on the fault location method for a distribution network. Alternatively, in other embodiments, the processor 11 may be configured as a fault location method for power distribution network in any other appropriate manner (e.g., by means of firmware).

Various implementations of the systems and technologies described above in the embodiments of the present disclosure may be implemented in digital electronic circuit systems, integrated circuit systems, field-programmable gate arrays (FPGA), application-specific integrated circuits (ASIC), application-specific standard products (ASSP), system-on-a-chip (SoC) systems, programmable logic devices (PLD), computer hardware, firmware, software, and/or combinations thereof. These various implementations may include implementation in one or more computer programs, where the one or more computer programs can be executed and/or interpreted on a programmable system including at least one programmable processor; the programmable processor may be a dedicated or general-purpose programmable processor, which can receive data and instructions from a storage system, at least one input device, and at least one output device, and transmit data and instructions to the storage system, the at least one input device, and the at least one output device.

Computer programs for implementing the methods of the embodiments of the present disclosure may be written in any combination of one or more programming languages. These computer programs may be provided to a processor of a general-purpose computer, a special-purpose computer, or another programmable data processing apparatus, such that when the computer programs are executed by the processor, the functions/operations specified in the flowcharts and/or block diagrams are implemented. A computer program may be executed entirely on a machine, partially on a machine, partially on a machine and partially on a remote machine as a stand-alone software package, or entirely on a remote machine or server.

In the context of the embodiments of the present disclosure, a computer-readable storage medium may be a tangible medium that can contain or store a computer program for use by or in connection with an instruction execution system, apparatus, or device. Computer-readable storage media may include, but are not limited to, electronic, magnetic, optical, electromagnetic, infrared, or semiconductor systems, apparatuses, or devices, or any suitable combination of the above contents. Alternatively, the computer readable storage medium may be a machine readable signal medium. More specific examples of machine-readable storage media would include electrical connections based on one or more wires, portable computer disks, hard disks, RAM, ROM, erasable programmable read-only memory (EPROM or flash memory), optical fibers, portable compact disc read-only memory (CD-ROM), optical storage devices, magnetic storage devices, or any suitable combination of the above contents.

To provide interaction with a user, the systems and technologies described herein may be implemented on a device that includes: a display device (e.g., a cathode ray tube or a liquid crystal display monitor) for displaying information to the user; and a keyboard and a pointing device (e.g., a mouse or a trackball), through which the user may provide input to the device. Other types of devices may also be used to provide interaction with the user; for example, the feedback provided to the user may be any form of sensory feedback (e.g., visual feedback, auditory feedback, or tactile feedback); and input from the user may be received in any form (including acoustic input, voice input, or tactile input).

The systems and technologies described herein may be implemented in a computing system that includes backend components (e.g., as a data server), a computing system that includes middleware components (e.g., an application server), a computing system that includes frontend components (e.g., a user computer with a graphical user interface or a web browser, through which a user may interact with implementations of the systems and technologies described herein), or a computing system that includes any combination of such backend components, middleware components, or frontend components. The components of the system may be interconnected via digital data communication of any form or medium (e.g., a communication network). Examples of communication networks include: local area networks, wide area networks, blockchain networks, and the Internet.

The computer system may include a client and a server. The client and the server are generally remote from each other and typically interact via a communication network. The client-server relationship is generated by computer programs that run on respective computers and have a client-server relationship with each other. The server may be a cloud server, also referred to as a cloud computing server or a cloud host, which is a host product in the cloud computing service system. It addresses the defects of high management difficulty and weak business scalability existing in traditional physical hosts and virtual private server services.

It should be understood that the various forms of processes shown above may be used, with steps reordered, added, or deleted. For example, the steps described in the present disclosure may be executed in parallel, sequentially, or in a different order as long as the desired result of the technical solution of the present disclosure can be achieved, which are not limited herein.

The above specific implementations do not constitute a limitation on the protection scope of the embodiments of the present disclosure. It should be understood by those skilled in the art that various modifications, combinations, sub-combinations, and substitutions may be made according to design requirements and other factors. Any modifications, equivalent substitutions, improvements, and the like made within the spirit and principles of the present disclosure shall be included within the protection scope of the present disclosure.

1. A fault location method for a power network, comprising:
acquiring node state data of at least one network node in a power network and constructing a power network state incidence matrix based on the node state data of each network node; and
determining a power grid characteristic constraint of the power network state incidence matrix and determining a fault section corresponding to the power network state incidence matrix according to the power grid characteristic constraint and a preset fault location model.

2. The method according to claim 1, wherein the step of acquiring node state data of at least one network node in a power network comprises:
by using the network nodes as vertices and a power transmission relationship among the network nodes as directed edges among the vertices, establishing a power network directed graph of the power network based on the vertices and the directed edges;
by using any one vertice in the power network directed graph as a benchmark node and other vertices as non-benchmark nodes, acquiring a fault additional item of the benchmark node and non-benchmark node state data of the non-benchmark nodes, wherein the fault additional item at least comprises: fault current increment term data, fault power increment data, and a benchmark node state error; and
adding the fault additional item and the non-benchmark node state data to obtain the node state data of the benchmark node.

3. The method according to claim 2, wherein the step of constructing a power network state incidence matrix based on the node state data of each network node comprises:
by using the fault additional item as a vector element, constructing a fault column vector, and by using the non-benchmark node state data as a vector element, constructing a non-benchmark node state column vector; and
constructing the power network state incidence matrix of the benchmark node based on the fault column vector and the non-benchmark node state column vector.

4. The method according to claim 1, wherein the step of determining a power grid characteristic constraint of the power network state incidence matrix comprises:
constructing a non-linear power network constraint of the power network state incidence matrix based on a preset operation requirement of the power network; and
performing equivalent relaxation on the non-linear power network constraint, and integrating an upper bound linear constraint and a lower bound linear constraint of the equivalently relaxed non-linear power network into the power grid characteristic constraint.

5. The method according to claim 1, wherein the step of determining a fault section corresponding to the power network state incidence matrix according to the power network characteristic constraint and a preset fault location comprises:
determining a target function corresponding to the power network state incidence matrix based on a preset optimization requirement;
in combination with the power network characteristic constraint, determining a minimum target function corresponding to the target function by means of the preset fault location model, and outputting a node section of the power network corresponding to the minimum target function, wherein a construction algorithm of the preset fault location model at least comprises: an artificial hummingbird algorithm; and
using the node section of the power network as the fault section of the power network.

6. The method according to claim 5, wherein the step of determining a fault section corresponding to the power network state incidence matrix according to the power network characteristic constraint and a preset fault location further comprises:
arranging a plurality of virtual fault points at equal intervals within the fault section, and collecting virtual electric data of each of the virtual fault points by using preset power system simulation software; and
identifying the virtual electric data by means of the preset fault location model, and outputting a precise fault point of the power network based on the virtual electric data.

7. A fault location device for a distribution network, comprising:
an incidence matrix construction module, configured to acquire node state data of at least one network node in a power network and construct a power network state incidence matrix based on the node state data of each network node; and
a fault section determination module, configured to determine a power network characteristic constraint of the power network state incidence matrix and determine a fault section corresponding to the power network state incidence matrix according to the power network characteristic constraint and a preset fault location model.

8. An equipment, comprising:
at least one processor; and
a memory in communication connection to the at least one processor, wherein
the memory stores a computer program capable of being executed by the at least one processor, the computer program being executed by the at least one processor to cause the at least one processor to perform the fault location method for a distribution network according to claim 1.

9. A computer-readable storage medium, comprising:
a computer instruction, configured to cause a processor to execute the computer instruction, so as to implement the fault location method for a distribution network according to claim 1.

10. A computer program product, comprising a computer program,
wherein when executed by a processor, the computer program implements the fault location method for a distribution network according to claim 1.
